(19) United States
(12) Patent Application Publication
(10) Pub. No.: US 2005/0051709 A1
(43) Pub. Date: Mar. 10, 2005

(54) NIGHT VIEWER ACCOMODATING MULTIPLE IMAGE TUBE TYPES

(75) Inventors: Michael J. ROSENDAUL, Tempe, AZ (US); Wayne ISBELL, Dallas, TX (US); James G. WINKEL, Dallas, TX (US); David W. BUCK, Garland, TX (US)

Correspondence Address: MARSTELLER & ASSOCIATES, P. C., P. O. BOX 803302, DALLAS, TX, 75380-3302, US

(73) Assignee: LITTON SYSTEMS, INC., Los Angeles, CA (US)

(21) Appl. No.: 10/707,051

(22) Filed: Nov. 18, 2003

Related U.S. Application Data
(60) Provisional application No. 60/481,024, filed on Jun. 25, 2003.

(51) Int. Cl. H01J 40/14

(52) U.S. Cl. 250/214 VT

(57) ABSTRACT

An adaptive electrical circuit unit (C) is used in a night viewer system (V) having an image intensifier tube (10) and a compatible power source (12). A voltage gain detection circuit unit (14) is operably connected to the image intensifier tube (10) and detects multiple selected types of image intensifier tubes (10). The voltage gain detection circuit (14) produces an output gain signal (16) that is appropriate to the detected image intensifier tube (10) for controlling the gain of the detected image intensifier tube (10).

### CROSS REFERENCE TO RELATED APPLICATIONS

This application claims the benefit of U.S. Provisional Application Ser. No. 60/481,024, filed Jun. 25, 2003, entitled NIGHT VIEWER ACCOMMODATING MULTIPLE IMAGE TUBE TYPES.

### BACKGROUND OF INVENTION

1. Technical Field

The invention relates to the field of image viewing devices, and more particularly to a night vision device accommodating multiple types of image intensifier tubes.

2. Background Art

Image viewing devices, such as image intensifier or thermal imaging night vision goggles, are used generally by members of the military as well as others for detecting or sensing images of a scene. Such image viewers typically require a power source to provide power for the included electrical circuitry.

Also, known night viewer systems generally are adapted to use a single type or model of image intensifier tube. Therefore, when the tube requires replacement in the field, the viewer must be repaired by replacement of the installed image intensifier tube with the same type.

One feature of the present invention reduces the number of batteries, from two to one, required to operate a night vision system, such as that designated the PVS-14 system by the U.S. Army, or other battery powered electrical devices that uses 2 known AA sized batteries.

A second feature of the present invention adapts a night vision system to use multiple types of image intensification tubes having different electrical connectors. Normally, the electrical contacts to establish an electrical between the tube and the system varies among tube types. Thus differing tube types often can not physically connect to a night viewer system because of the contact arrangement. By using the present invention in a night vision system, the original image intensification tube included with the system can be replaced by tube types that differ from the originally supplied tube type. Being able to use multiple tube types results in reducing the down time for a night viewer system that is attributable to an image tube requiring replacement may be reduced in the field by permitting a wider range of replacement tube types. The ability to use multiple tube types may also reduce waste and cost.

Night vision systems are currently available and have been used by the US military and others that require only one battery. These systems use the voltage from one battery and produce an output voltage that will operate the night vision system. An example of such a system is U.S. Pat. No. 5,130,527, issued Jul. 14, 1992.

While the above cited references introduce and disclose a number of noteworthy advances and technological improvements within the art, none completely fulfills the specific objectives achieved by this invention.

### SUMMARY OF INVENTION

In accordance with the present invention, an adaptive electrical circuit unit is used in a night viewer system having an image intensifier tube and a compatible power source. A voltage gain detection circuit unit is operably connected to the image intensifier tube and detects multiple selected types of image intensifier tubes. The voltage gain detection circuit produces an output gain signal that is appropriate to the detected image intensifier tube for controlling the gain of the detected image intensifier tube.

The present invention consists of an electrical circuit that senses the electrical or mechanical connection characteristics for various selected types of image intensifier tubes and controls the power supply and other electrical circuit features responsive to the tube that is inserted into the night viewer. Furthermore, it is desired that the battery compartment of the night vision system that normally uses two batteries is modified to receive a single battery.

The main body contains electronic circuitry with terminals that connect the preferred single battery to the electronic circuitry and the electronic circuitry to and from the image intensification tube of the night vision system. The electronic circuitry converts a single battery input voltage to a level that will operate the night vision system and determines the electrical characteristics of the tube connected to the night viewer body.

These and other objects, advantages and features of this invention will be apparent from the following description taken with reference to the accompanying drawings, wherein is shown the preferred embodiments of the invention.

### BRIEF DESCRIPTION OF DRAWINGS

A more particular description of the invention briefly summarized above is available from the exemplary embodiments illustrated in the drawings and discussed in further detail below. Through this reference, it can be seen how the above cited features, as well as others that will become apparent, are obtained and can be understood in detail. The drawings nevertheless illustrate only typical, preferred embodiments of the invention and are not to be considered limiting of its scope as the invention may admit to other equally effective embodiments.

FIG. 1 is a schematic diagram of the electrical circuit of the present invention.

FIGS. 2A-2C is a series of three schematic block diagrams illustrating the ability of the present invention to electronically bias Gain Control for three different image intensifier tube options.

### DETAILED DESCRIPTION

So that the manner in which the above recited features, advantages, and objects of the present invention are attained can be understood in detail, more particular description of the invention, briefly summarized above, may be had by reference to the embodiment thereof that is illustrated in the appended drawings. In all the drawings, identical numbers represent the same elements.

An adaptive electrical circuit unit C is used in a night viewer system V having an image intensifier tube 10, which tube 10 takes an input signal In and generates a desired output signal Out, and a compatible power source 12. A voltage gain detection circuit unit 14 is operably connected to the image intensifier tube 10 and detects multiple selected types of image intensifier tubes 10. The voltage gain detection circuit 14 produces an output gain signal 16 that is appropriate to the detected image intensifier tube 10 for controlling the gain of the detected image intensifier tube 10.

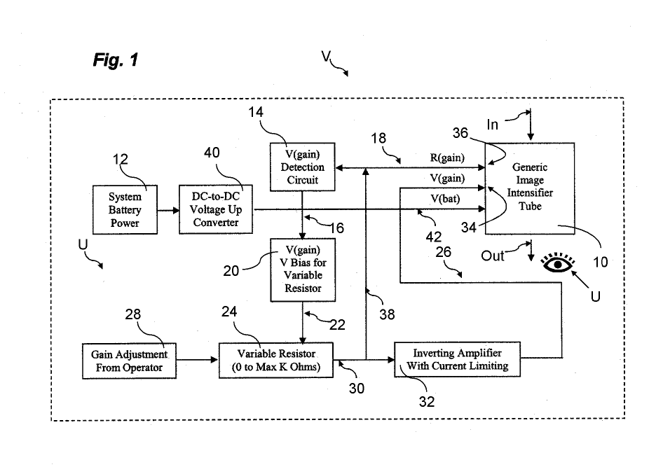

The Three Tube Selection block diagram of FIG. 1 illustrates the ability to electronically bias the Gain Control for three different tube 10 options or types. There are three Gain options; one for Resistive Gain Control, another for Voltage Gain Control, and the third is no external gain control. FIG. 1 illustrates these three options.

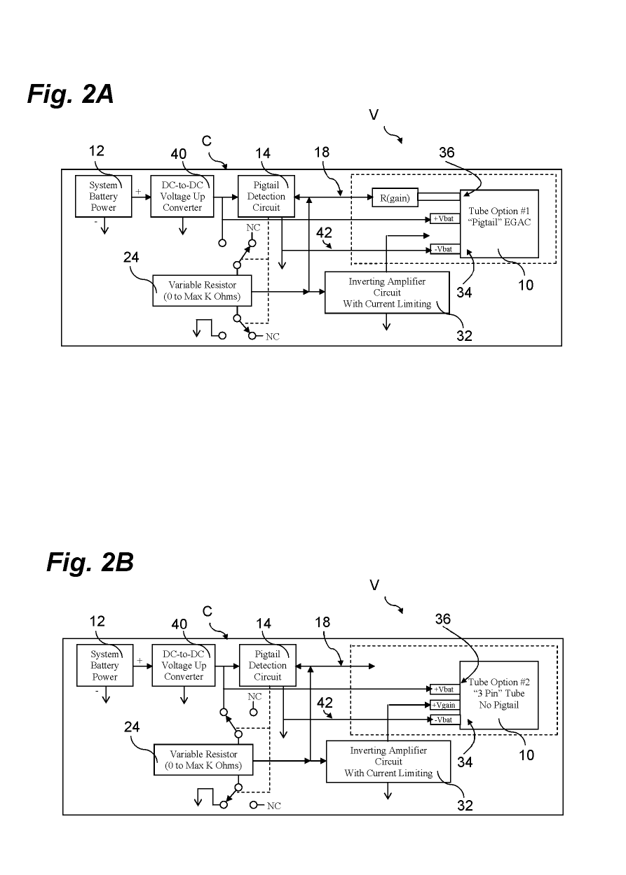

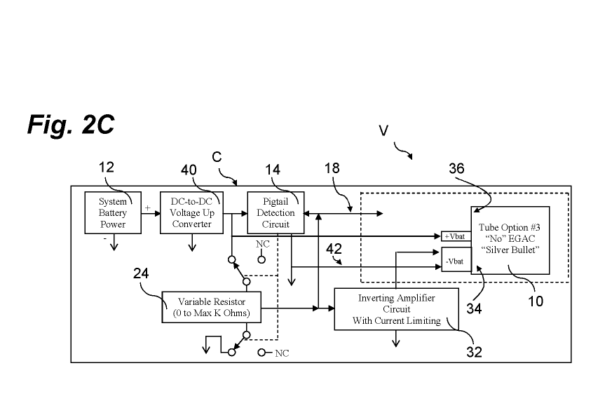

The series of three schematic block diagrams, FIGS. 2A through 2C, illustrate the ability of the present invention to electronically bias Gain Control for three different image intensifier tube 10 type options. A different tube 10 type is shown in each FIG. 2A-2C. Each of the tube types generally have different electrical connections or pigtails. There are two Gain options; one for Resistive Gain Control, and another for Voltage Gain Control.

Option 1 (FIG. 2A): The V (gain) or Pigtail Detection component 14 receives a R (gain) requirement signal 18 from the image intensifier tube 10 and sends a signal 16 to the V Bias circuit component 20 that develops a signal 22 to cause the functional disconnection of a Variable Resistor unit 24 from the Bias Voltages 26 for operating the tube 10. The R (gain) connection 18 to the tube 10 contains only the Variable Resistor 28 that is controlled by an user or operator U.

Option 2 (FIG. 2B): The V (gain) Detector 14 receives a V (gain) requirement signal from the tube 10 and sends a signal 16 to the V Bias circuit 20 that operably connects to the Variable Resistor unit 24 to generate the appropriate Bias Voltage signal 26 to the tube 10. The R (gain) signal 18 is not functionally connected to the tube 10 due to a missing terminal on specific types of a tube 10. The Variable Resistor block 24 is controlled by the operator uand feeds a variable voltage signal 30 to the Inverting Amplifier circuit component 32, which connects to a V (gain) terminal 34 on the tube 10.

Option 3 (FIG. 2C): The V (gain) or Pigtail Detector 14 receives a No External Gain requirement signal 18 from the tube 10 (which is the same signal as the V (gain) requirement) and sends a signal 16 to the V Bias circuit portion 20 that functionally connects the Variable Resistor unit 24 to the Bias Voltages 26. The R (gain) is not connected to the tube 10 due to a missing terminal 36 on the tube 10. The V (gain) terminal 34 is not on the tube 10, but could be shorted to a metal housing of the tube 10 or other suitable electrical ground. For this reason the V (gain) signal output 26 is current limited by the amplifier circuit component 32.

Preferably, a signal 38 is also communicated from the variable resistor unit 24 to either the tube 10 or as an input to the V (gain) Detector circuit 14.

The power source 12 for typical image intensifier night viewer systems V generally includes two known AA battery cells connected in order to provide an electrical signal equivalent to approximately 1.5 volts DC each or 3 volts total. An embodiment of the present invention includes a known type of Direct Current (“DC”) to DC voltage step-up circuit component 40 to multiply the voltage from a reduced number of selected batteries to make the resulting electrical signal 42 equivalent to the required voltage. Typically, the dual AA cell batteries are reduced to a single AA cell battery that means the 1.5 volt DC signal from the AA battery must be doubled or multiplied by two to be the functional equivalent of the normal two AA batteries required.

In an alternative embodiment a single AA battery that produces 3.6 volts DC signal when operational may be used. This 3.6V battery type may operate normally in the circuitry, in that a Low Battery Indicator, which may form a part of the night viewer system V, will correctly determine an End-Of-Life voltage and indicate to the operator that the battery is near End-of-Life well in advance of the loss of operation.

The foregoing disclosure and description of the invention are illustrative and explanatory thereof, and various changes in the size, shape and materials, as well as in the details of the illustrated construction may be made without departing from the spirit of the invention.

1. An adaptive electrical circuit unit for use in a night viewer system of the type that uses an image intensifier tube and a compatible power source, the invention comprising:
a voltage gain detection circuit unit operably connected to the image intensifier tube for detecting multiple selected types of image intensifier tubes and producing an output gain signal appropriate to the detected image intensifier tube for controlling the gain of the detected image intensifier tube.

2. The invention of claim 1 further including a voltage bias circuit unit operably connected between the voltage gain detection circuit unit and the image intensifier tube for providing a desired voltage gain signal to the image intensifier tube in response to the output gain signal from the voltage gain detection circuit unit.

3. The invention of claim 1 further including a variable resistor circuit unit operably connected between the voltage gain detection circuit unit and the image intensifier tube for providing a desired voltage level signal to the image intensifier tube.

4. The invention of claim 3 wherein the variable resistor circuit further includes a manual gain adjustment means for manually adjusting the desired voltage level signal to the image intensifier tube by a user.

5. The invention of claim 1 further including an amplifier circuit unit operably connected between the voltage gain detection circuit unit and the image intensifier tube for providing a desired amplified voltage signal to the image intensifier tube for bias adjustment of the image intensifier tube.

6. The invention of claim 5 further including a current limiting circuit unit for controlling an amount of electrical current of the amplified voltage signal to the image intensifier tube.

7. The invention of claim 5 further including a variable resistor circuit operably connected between the amplifier circuit unit and the voltage gain detection circuit unit for providing a desired voltage level signal to the amplifier circuit unit.

8. The invention of claim 1 further including an amplifier circuit unit operably connected between the variable resistor circuit unit and the image intensifier tube for providing a desired voltage signal to the image intensifier tube.

9. The invention of claim 1 wherein the power source includes a direct current (DC) to direct current (DC) voltage step-up converter circuit unit for providing a desired power supply voltage signal to the image intensifier tube.

10. The invention of claim 7 wherein the DC to DC voltage step-up converter circuit boosts the voltage of the power source by two times.

11. A method for using multiple image intensifier tube types in a night viewer system of the type that includes a compatible power source, the method comprising the steps of:
detecting a specific image intensifier tube type from a multiple selected types of image intensifier tubes using a voltage gain detecting circuit unit operably connected to the image intensifier tube; and,
producing an output gain signal appropriate to the detected image intensifier tube for controlling the gain of the detected image intensifier tube.

12. The method of claim 11 further including a voltage bias circuit unit operably connected between the voltage gain detection circuit unit and the image intensifier tube for providing a desired voltage gain signal to the image intensifier tube in response to the output gain signal from the voltage gain detection circuit unit.

13. The method of claim 11 further including the step of providing a desired voltage level signal to the image intensifier tube using a variable resistor circuit unit operably connected between the voltage gain detection circuit unit and the image intensifier tube.

14. The method of claim 13 wherein the variable resistor circuit further includes a manual gain adjustment means for manually adjusting the desired voltage level signal to the image intensifier tube by a user.

15. The method of claim 11 further including the step providing a desired amplified voltage signal to the image intensifier tube for bias adjustment of the image intensifier tube using an amplifier circuit unit operably connected between the voltage gain detection circuit unit and the image intensifier tube.

16. The method of claim 15 wherein the amplifier circuit unit further includes a current limiting circuit unit for controlling an amount of electrical current of the amplified voltage signal to the image intensifier tube.

17. The method of claim 15 further including a variable resistor circuit operably connected between the amplifier circuit unit and the voltage gain detection circuit unit for providing a desired voltage level signal to the amplifier circuit unit.

18. The method of claim 11 further including the step of providing a desired voltage signal to the image intensifier tube using an amplifier circuit unit operably connected between the variable resistor circuit unit and the image intensifier tube.
